(19) United States
(12) Patent Application Publication
(10) Pub. No.: US 2002/0045088 A1
(43) Pub. Date: Apr. 18, 2002

(54) Bipolar collectors characterised by discrete collection of the charges

(76) Inventor: Guy Bronoel, Versailles (FR)

Correspondence Address: HENDERSON & STURM LLP, 1213 MIDLAND BUILDING, 206 SIXTH AVENUE, DES MOINES, IA, 50309-4076, US

(21) Appl. No.: 09/968,929

(22) Filed: Oct. 1, 2001

Related U.S. Application Data
(63) Continuation of application No. PCT/FR00/00843, filed on Apr. 5, 2000.

(30) Foreign Application Priority Data
Apr. 7, 1999 (FR) 99.04277

(51) Int. Cl. H01M 4/96; H01M 4/86; H01M 8/02

(52) U.S. Cl. 429/42; 429/34; 429/44

(57) ABSTRACT

The invention concerns bipolar collectors with discrete collecting of charges for a fuel cell comprising a screen (A) having good electronic conductivity and electronically conductive needles (B) through which the charges flow, said needles being placed perpendicularly to the surface of the screen separating two adjacent elements but not passing through them and embedded on either side in blind holes distributed over the surface of the screen in contact with the electrodes. The screen consisting of a polymer made conductive by addition of a conductive charge, is optionally grooved on its main surface so as to provide passages (D) for gas circulation or comprises pins (E) defining a space on either side of its main surfaces wherein the gases can circulate.

### CROSS-REFERENCE TO RELATED APPLICATIONS

This application is a continuation application, which is being filed as the national phase of International Application No. PCT/FR00/00843 filed Apr. 5, 2001, which claims priority of French Patent Application No. 99.04277 filed Apr. 7, 1999 and is hereby incorporated herein by reference.

### BACKGROUND OF THE INVENTION

1. Field of the Invention

The present invention relates to bipolar collectors with discrete collection of the charges, for fuel cells, characterised in that the electronically conductive needles in which the charges flow are placed perpendicularly to the surface of the collectors which separate two adjacent cell elements, but do not pass through them, the said collectors necessarily having good electronic conductivity.

2. Description of Related Art

French patent application no. 98 09236 filed on Jul. 21, 1998, to Bronoel claimed the design of a bipolar collector for a fuel cell, characterised in that the charges are collected by electronically conductive needles, the two ends of which are in contact with the electrodes which belong to the two elements which must be placed in series electrically. The needles pass through a polymer plate, perpendicularly to the surface of the latter, the plate or screen having the function of separating the elements (or elementary cells) from one another, such that the gas which supplies a cell cannot be mixed with that which supplies the adjacent cell.

The aforementioned patent application specifies the number, distribution, and dimensions of the needles. In addition, according to one embodiment, it is presented as being advantageous for the screen not to have channels for feeding of the gases, but a space which is provided between the screen and the electrodes, which space is filled by an open three-dimensional structure such as a foam, the function of which is to homogenise the flow of gas which circulates in front of the electrodes. In all cases, the screen consists of an electrically insulating material.

Several methods for fitting the needles in the screen have been envisaged, whether the latter has channels or not. In all cases, these methods (studding, binding, gluing, insertion during moulding) must lead to perfect impermeability to the gases, between the two surfaces of the screen.

However, it has been observed, for certain methods of use, which for example involve rapid thermal cycles and a high amplitude, that detachment takes place between the surface of the electronically conductive needles and the screen, thus leading to a possible leakage of the gas from one compartment to the other.

### BRIEF SUMMARY OF THE INVENTION

An object of the present invention is to eliminate this disadvantage, by modifying the methods for fitting the needles in the screen, and consequently modifying the design of the latter. On the other hand, the present invention does not relate to the distribution of the needles, their nature, and their surface protection, the innovation relating to the discrete collection of the charges being specific to the aforemention French Patent Application No. 98 09236.

According to one of the characteristics of the invention, the electronically conductive needles causing the charges to flow are placed perpendicularly to the surface of the bipolar collector or screen, separating two adjacent cell elements, but not passing through them. Consequently the screen must necessarily have good electronic conductivity.

The conduction of the electrons from one electrode of an element, to the electrode with the opposite polarity situated in the adjacent element, therefore takes place in three successive media:

in a needle, one end of which is in contact with an electrode, and the other is embedded in the screen which has good electronic conductivity;

in the central part of the screen; and

in a second needle, one end of which is embedded in the screen, and the other being in contact with the electrode of the other element.

According to another characteristic of the invention, the screen which separates two adjacent cell elements consists of a composite material, comprising a polymer, which is made conductive by a conductive charge such as carbon.

The design according to the present invention is applicable to the two types of bipolar collectors described in the aforementiond French Patent Application No. 98 09236, which is in corporated herein by reference.

In fact, according to a characteristic of the invention, the screen is grooved on its main surfaces, in order to create channels where circulation of the gases takes place.

According to this embodiment, the needles which assure the flow of the charges are embedded in blind holes, which are distributed on the parts of the screen which are in relief, i.e. in the space which separates the channels.

According to another characteristic of the invention, the screen is not grooved, but a space is defined by the set of pins, on each side of its main surfaces, in which space the gases can circulate. The homogeneousness of the flows of gas is assured by the presence in the said space of a three-dimensional structure with open porosity, which is made of a conductive or insulating material. In this case, the needles which assure the flow of the charges are distributed on the two surfaces of the screen, and are embedded in blind holes.

In the first type of embodiment, which is characterised by the presence of channels on each surface of the screen, the electrodes are placed on the surfaces in relief which separate the channels. Each needle can be embedded in holes, the depth of which will be equivalent to half the thickness of the screen, less a value of between 0.1 and 0.5 mm according to the thickness of the screen, such that there remains a median fraction of the screen which is not perforated, and has a minimal thickness defined according to the nature of the material which constitutes the screen, and the mechanical stresses which are applied to it.

According to one embodiment, the holes for embedding of the needles are on both sides of each surface, in the extension of one another, the base of each hole being separated from that which is opposite it by a wall, the thickness of which is between 0.4 and 0.8 mm.

According to another embodiment, the embedding holes are not in the extension of one another. In this case, their depth can be greater than half the thickness of the screen, the distance from the base of an embedding to the closest surface nevertheless having to be greater than 0.3 mm, and the distance between the generatrices of the two opposite needles must be between 0.4 and 1 mm. The needles advantageously consist of stainless steel 316 L, and have a diameter of between 0.1 and 0.3 mm.

Taking into account the fact that the screen must have good electronic conductivity, it could be considered that the addition of electronically conductive needles constitutes an element which is superfluous for conduction. In fact, it must be noted that in this type of embodiment, the drainage of the charges by the needles can be a preferred mode, and consequently the material used to constitute the screen can be a compound, the conductivity of which can be less high than that needed in the absence of needles, if necessary as far as its use is concerned. Or, using this same material, it will be possible to make the system function with current densities which are higher than in the case of a material without implantation of needles, for the same ohmic drop.

Furthermore, it will also be possible to reduce the total area of the screen which is in contact with the electrode, and consequently to cut off the electrode less from the gases.

The collectors according to the invention advantageously have an electronically conductive film which is interposed between the surface of the embeddings, and the embedded part of the needles, in order to decrease the contact resistance. This conductive film consists of graphite, or glue with a high content of graphite.

### BRIEF DESCRIPTION OF THE DRAWINGS

Other characteristics and advantages of the present invention will become more apparent from reading the following description, with reference to the attached figures, which represent the following respectively:

FIG. 1 is a view in cross-section of a bipolar collector according to the invention, this collector comprising grooves on each of its main surfaces; and

FIG. 2 is a view in cross-section of a bipolar collector according to the invention, this collector not comprising grooves, but pins which define a space with a height which is pre-determined for circulation of the gases; in this FIG. 2, two embodiments have been grouped together, according to whether the needles which are situated on both sides of the screen are in the extension of one another, or are offset relative to one another.

### DETAILED DESCRIPTION OF THE INVENTION

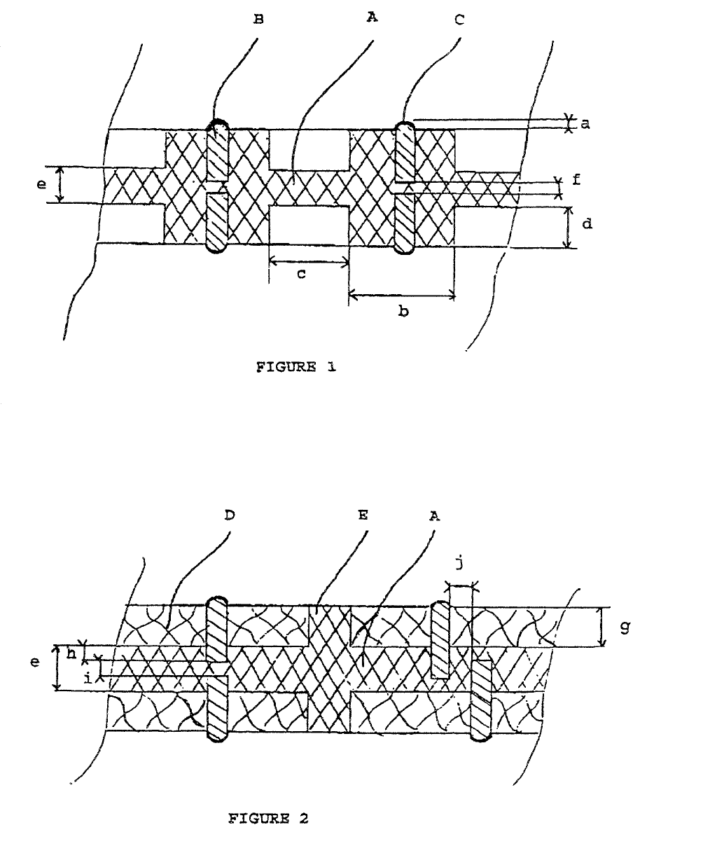

In the example represented in FIG. 1, the screen (A) comprises a polymer/carbon compound, the resistivity of which is approximately 1 Ωcm.

The needles (B) have a diameter of between 0.1 and 0.3 mm, and in this case 0.2 mm, they are made of stainless steel 316 L, and their total length is 1.5 mm. Their part which projects from the reliefs of the screen (a) is between 0.1 and 0.3 mm, and in this case is 0.2 mm. As claimed in the aforementioned French Patent Application No. 98 09236, the surface of the projecting end (C) of the needle is advantageously coated with a deposit of protective metal or alloy, to prevent passivation, in particular in the case of the needles which penetrate the positive electrodes. The width (b) of the bands which separate the channels is between 0.5 and 1 mm. In the example which is described and produced, it is 0.8 mm. The width (c) of the channels is generally between 1 and 3 mm. In this case it is 2 mm.

The depth of the channels (d) is between 0.8 and 1.5 mm. In this case it is 1 mm. The thickness (e) of the screen between the base of two channels is approximately 1 mm. The thickness (f) of the screen between the base of the receptacles which are designed for the needles is in this case 0.4 mm, and the embeddings are in the extension of one another.

The embeddings (substantially cylindrical holes) which are designed for implantation of the needles, can be produced either during moulding of the screen, or by subsequent machining. They have a diameter which is equal to that of the needles, or greater than 0.05 mm.

The distance between the needles, and more generally their distribution, is to be defined according to the electronic conductivity of the electrodes, the current densities generated, and the maximum ohmic drop which can be tolerated.

FIG. 2 represents the second type of bipolar collector, which is characterised by the absence of channels. The gases circulate in the space contained between the surface of the electrodes and the inner surface of the screen (A), and the thickness (g) of this space is generally between 0.8 and 1.5 mm, and in this case 1 mm. This space can advantageously be filled by an open three-dimensional structure (D), such as in this case a foam with open alveoles, made of a low-density polymer, which is stable in the conditions of functioning of the cell, and is not necessarily conductive. This structure, the average diameter of the alveoles of which is 0.5 mm, serves the purpose of homogenising the flows of gas. As had been stated in the aforementioned French Patent Application No. 98 09236, it is advantageous for the material which constitutes this structure to have a hydrophobic character.

The screen can advantageously comprise pins (E), the diameter of which is for example 3 mm, in order to standardize the thickness of the stream, these pins which project from the plate constituting most of the screen, and having a height (g) which is equal to the thickness of the stream.

The thickness (e) of this screen plate is generally between 0.8 and 1.5 mm. The penetration (h) of the needles in the plate is between 0.3 and 0.8 mm, the diameter of the needles, their component material, and the method of protection of their end being identical to those described in the preceding example. Also as in the first example, the length of penetration of the needles in the electrodes is approximately 0.2 mm. The result is that the total length of the needles is between 1.2 and 2.6 mm. It will be noted that, as shown in FIG. 2, two modes of relative arrangement of the needles are possible. In the first case, the needles on both sides of the screen are in the extension of one another. In this case, the distance (i) between the base of each embedding is between 0.4 and 1 mm, this distance advantageously being as short as possible, but in fact being defined by the conditions of implementation of the screen.

Another particularly advantageous arrangement for collectors without channels consists in that the needles which are situated on both sides of the screen are not in the extension of one another. The result in this case is that the distance (j) between the generatrices of the two cylinders must also be as short as possible, and in all cases must be between 0.4 and 1 mm. According to this configuration, it is possible to provide greater penetration of the needle in the screen, than in cases in which the needles are in the extension of one another.

The present invention is not limited to the examples previously described, but incorporates all variants.

1. Bipolar collectors with discrete collection of the charges, for fuel cells, characterised in that the electronically conductive needles by means of which the charges flow are placed perpendicularly to the surface of the collectors which separate two adjacent cell elements, but do not pass through them, the said collectors necessarily having good electronic conductivity.

2. Bipolar collectors according to claim 1, characterised in that the screen which separates two adjacent cell elements consists of a composite material, in which a polymer is made conductive by a conductive charge such as carbon.

3. Bipolar collectors according to claim 1 and claim 2, characterised in that the screen is grooved on its main surfaces, in order to create channels where circulation of the gases takes place.

4. Bipolar collectors according to claim 1 and claim 2, characterised in that the screen is not grooved, but a space is defined by the set of pins, on each side of its main surfaces, in which space the gases can circulate, the homogeneousness of the flows of gas being assured by the presence in the said space of a three-dimensional structure with open porosity, which is made of a conductive or insulating material.

5. Bipolar collectors according to claim 3, characterised in that the needles which assure the flow of the charges are embedded in blind holes, which are distributed on the parts of the screen which are in relief, i.e. in the space which separates the channels.

6. Bipolar collectors according to claim 4, characterised in that the needles which assure the flow of the charges, and are distributed on both surfaces of the screen, are embedded in holes which are not blind.

7. Bipolar collectors according to claim 5 and claim 6, characterised in that the holes for embedding of the needles are on both sides of each surface, in the extension of one another, the base of each hole being separated from that which is opposite it by a wall, the thickness of which is between 0.4 and 0.8 mm.

8. Bipolar collectors according to claim 5 and claim 6, characterised in that the embedding holes are not in the extension of one another, and in these conditions, their depth can be greater than half the thickness of the screen, the distance from the base of an embedding to the closest surface nevertheless having to be greater than 0.3 mm, and the distance between the generatrices of the two opposite needles must be between 0.4 and 1 mm.

9. Bipolar collectors according to claim 1, characterised in that the needles are made of stainless steel 316 L, and have a diameter of between 0.1 and 0.3 mm.

10. Bipolar collectors according to claim 5 and claim 6, characterised in that an electronically conductive film can be interposed between the surface of the embeddings, and the embedded part of the needles, in order to decrease the contact resistance.

11. Bipolar collectors according to claim 10, characterised in that the conductive film consists of graphite, or glue with a high content of graphite.
